(19) United States
(12) Patent Application Publication
(10) Pub. No.: US 2010/0138247 A1
(43) Pub. Date: Jun. 3, 2010

(54) System and method for managing enterprise capabilities

(75) Inventors: Adrian John Botham, Blackburn (GB); Paul Russell, Blackburn (GB); James Anthony Tyson, Blackburn (GB)

Correspondence Address: BUCHANAN, INGERSOLL & ROONEY PC, POST OFFICE BOX 1404, ALEXANDRIA, VA, 22313-1404, US

(73) Assignee: BAE SYSTEMS plc, London (GB)

(21) Appl. No.: 12/292,865

(22) Filed: Nov. 28, 2008

(51) Int. Cl. G06Q 10/00; G06F 17/30

(52) U.S. Cl. 705/7; 707/E17.001

(57) ABSTRACT

Systems and methods are disclosed for managing enterprise capabilities. The system comprises a database that stores a plurality of capability templates in an asset library. The system also includes a user interface configured to communicate with the database and receive capability data for a user project, and a processor configured to analyze the capability data based on at least one of the capability templates and generate a capability profile of the user project based on the analysis. A display is included in the system to output the capability profile.

### FIELD

A system and method for managing enterprise capabilities, and more particularly for governing and managing the capabilities across any of the various programs and disciplines of an enterprise, such as, supply chain management are disclosed.

### DESCRIPTION OF THE RELATED ART

The Capability Maturity Model (CMM) is a process capability maturity model, which aids in the definition and understanding of an organization's processes. A maturity model can be described as a structured collection of elements that describe certain aspects of maturity in an organization.

A maturity model can be used as a benchmark for comparison and as an aid to understanding for example, for comparative assessment of different organizations where there is something in common, that can be used as a basis for comparison.

Capability Maturity Model Integration (CMMI) is a process improvement approach that provides organizations with the essential elements of effective processes. It can be used to guide process improvement across a project, a division, or an entire organization. CMMI helps integrate traditionally separate organizational functions, set process improvement goals and priorities, provide guidance for quality processes, and provide a point of reference for appraising current processes. As the name suggests CMMI integrates several CMMs and provides a framework for business process improvement.

Supply chain management (SCM) is the process of planning, implementing and controlling the operations of a supply chain. A supply chain can be defined as an integrated system of functions, people, processes, information, and resources that adds value to the two-way flow of goods and information between source and user. Supply Chain Management spans all movement and storage of raw materials, work-in-process inventory, and finished goods from point-of-origin to point-of-consumption.

### SUMMARY

An exemplary system is disclosed for managing enterprise capabilities. The exemplary system comprises a database that stores a plurality of capability templates in an asset library. The system also includes a user interface configured to communicate with the database and receive capability data for a user project, and a processor configured to analyze the capability data based on at least one of the capability templates and generate a capability profile of the user project based on the analysis. A display is included in the system to output the capability profile.

Exemplary methods are disclosed for managing enterprise capabilities. These methods include acquiring capability data for a project and analyzing the capability data based on a capability template stored in a database. The method further comprises establishing a capability profile of the project based on the analysis, and displaying the capability profile.

Other exemplary methods for managing capabilities of a subgroup in an enterprise are disclosed. The methods comprising generating a capability profile for the subgroup, customizing, for the subgroup, at least one capability included in the capability profile, and deploying, to a project, each capability included in the capability profile.

Still other exemplary methods are disclosed for governing and assuring capability management in an enterprise. The method comprising deploying a governance and assurance framework across each subgroup of the enterprise, and implementing mechanisms for at least one of assessing, developing, and deploying capabilities of each subgroup for a project. The mechanisms being configured to establish a managing policy for the capabilities based on the governance and assurance framework such that best practices for the enterprise are sustainable, transferable, affordable, and repeatable in each subgroup of the enterprise.

### BRIEF DESCRIPTION OF THE DRAWINGS

Exemplary preferred embodiments will be described in conjunction with the accompanying drawings, wherein like elements are represented by like reference numerals, and wherein:

FIG. 1 illustrates an overview of a system in accordance with an exemplary embodiment;

FIG. 2 is a flow diagram for a method of managing enterprise capabilities in accordance with an exemplary embodiment;

FIG. 3 is a flow diagram for a method of analyzing capability data in accordance with an exemplary embodiment;

FIG. 4 is a flow diagram for a method of managing capabilities in a subgroup of an enterprise in accordance with an exemplary embodiment;

FIG. 5 is a flow diagram for a method of generating a capability profile in accordance with an exemplary embodiment;

FIG. 6 is a flow diagram for a method of customizing capabilities in accordance with an exemplary embodiment;

FIG. 7 is a flow diagram for a method of adjusting a capability in accordance with an exemplary embodiment; and

FIG. 8 is a flow diagram for a method of governing and assuring capability management in an enterprise

### DETAILED DESCRIPTION

The following embodiments are directed to systems and methods for managing supply chain capabilities of an enterprise or organization. The disclosed system is based on a CMMI construct such that the capabilities of the organization can be deployed to contracts, projects, or other tasks as needed, in a sustainable, transferable, repeatable, and affordable manner. The capabilities are sustainable in that they maintain robust, reliable performance over the life of the project. The capabilities are transferable because they can be replicated as needed across land, air, or sea environments or programs. The capabilities are repeatable because they are applicable across multiple projects with minimal variation or additional investment. The capabilities are affordable such that minimum overhead is needed, duplication of investment is minimized, and operations are simplified to become lean and efficient.

A capability is an attribute or asset of an enterprise that enables the enterprise to achieve a desired objective. The capability can include any combination of processes, tools, and people as desired to meet the objective. The processes can involve a sequence of activities and actions necessary to achieve a desired outcome. The tools can include physical and information systems infrastructure that is necessary to implement the processes effectively and efficiently. The people aspect of the capability can include human skills, behavior, and knowledge for executing the processes with the available tools. The processes, tools, and people are not limited to the aforementioned characteristics, and can include any additional or alternative attributes that enable the enterprise to complete the objective.

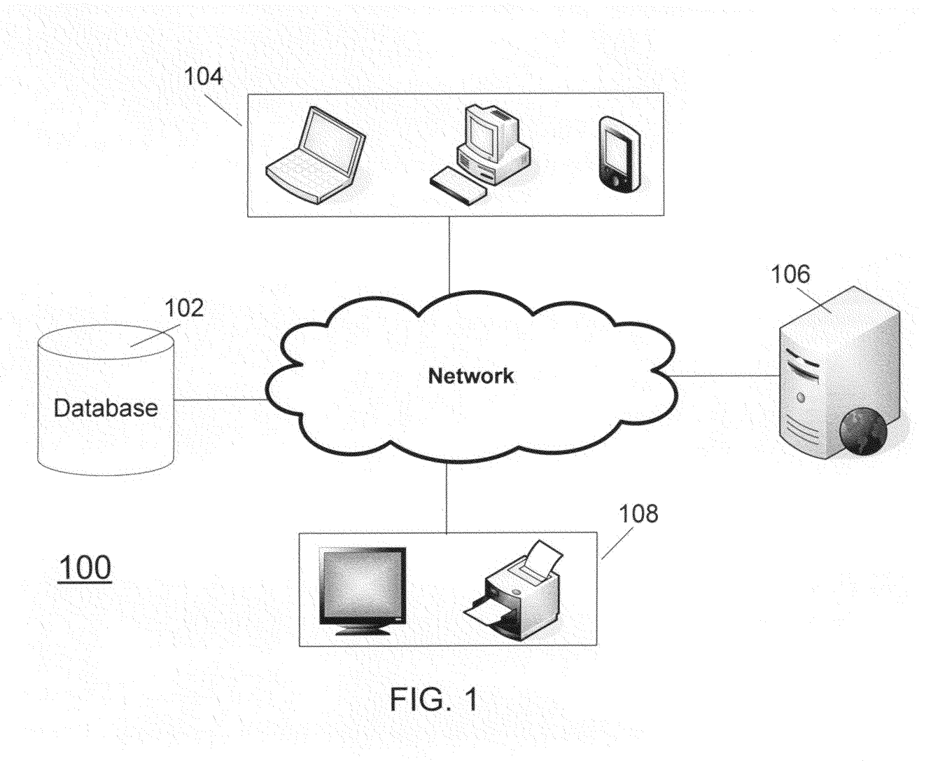

FIG. 1 illustrates an overview of a system 100 for managing enterprise capabilities in accordance with an exemplary embodiment. The system 100 includes a database 102, a user interface 104, a processor 106, and an output device 108. The database 102, the user interface 104, the processor 106, and the display 108 can be connected through a distributed network, such as a wide area network (WAN), local area network (LAN), or any other classification of network as desired. The network can be implemented through any one or combination of various connection technologies including Optical fibre, Ethernet, Wireless LAN, HomePNA, Power line communication, or any other technology as desired.

The database 102 stores plural capability templates in an asset library. The capability templates can be indexed, categorized, and/or grouped based on the various services that are provided by the organization. Each capability template includes data and/or information associated with the processes, tools, and people of the capability. For example, the capability template can identify any of practices, procedures, activities, metrics, skills, tools, infrastructure, information technology, systems, equipment, buildings, expertise, intellectual property, training material, lessons learned, control mechanisms, role definitions, and other data and/or information as desired, which are fundamental to achieving the objective.

In association with the capability template, the database 102 stores at least one generic capability. The generic capability can identify elemental processes, tools, and/or people needed to achieve an objective. Moreover, the data and/or information provided in the capability template can include guides, methods, processes, graphs, or any other information that can assist the enterprise in further developing or customizing the generic capability to meet the desired objective. One of ordinary skill will recognize that the database can be implemented through any of various known database management software packages and systems where the asset library is accessible over a network.

The user interface 104 is configured to communicate with the database 102 and receive capability data from a user. The user interface 104 enables a user to input capability data and transmit that capability data to the database 102, processor 106, or output device 108. The user interface 104 can be configured to prompt the user for information or present an intuitive display that directs the user to input information and present data stored in the database 102 based on a user input. The user interface 104 can be implemented as a graphical user interface based on object-oriented or application-oriented principles, as a web user interface based on web page principles, or using any other principle that enables a user to manipulate data and/or information stored in the database 102. The interface 104 can be implemented through any one of various computing devices, such as a personal computer, computer workstation, handheld computing device, or any other computing device as desired.

The processor 106 is configured to analyze the user capability data based on the capability template and generate a capability profile of the user based on the analysis. The processor 106 can be implemented through a stand-alone computing device, such as a server or other computing device connected to the network. In an alternative embodiment, the processor 106 can be implemented through the processing unit included in the user interface 104.

The output device 108 outputs the capability profile generated by the processor 106. The output device 108 can be implemented through any known peripheral device, such as a monitor, display, printer, or other suitable output device as desired.

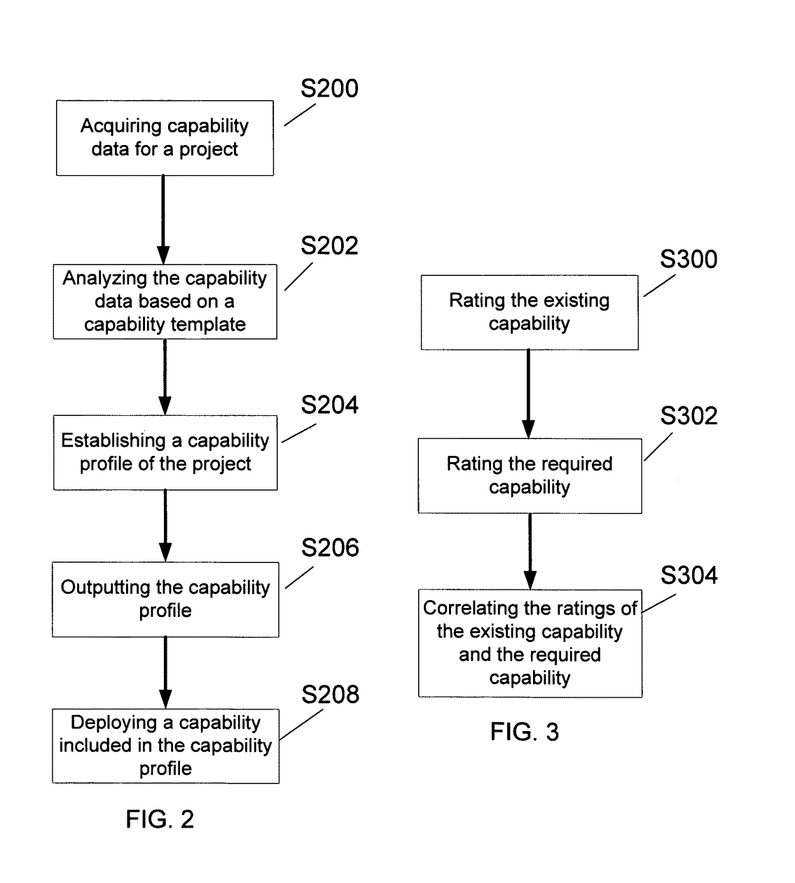

FIG. 2 is a flow diagram for a method of managing enterprise capabilities in accordance with another exemplary embodiment.

In performing the method, the system 100 acquires capability data from a user (S200). The capability data is acquired from the user via the user interface 104. The user inputs information that describes the existing processes, tools, and/or people that would be used to complete a project or objective. The user capability data also identifies capability needs or requirements of the user with respect to completing the project or objective. The user interface 104 can communicate the capability data input by the user to the database 102, the processor 106, and the output device 108. The processor 106 receives the capability data from the user interface 104 and extracts a capability template from the database 102. The extracted capability template includes data and information that is related to the project or objective under which the capability data of the user was input.

FIG. 3 is a flow diagram for a method of analyzing capability data in accordance with another exemplary embodiment. As shown in FIG. 3, the processor 106 rates the existing capability of the user (S300). The capability rating of the existing capability is determined based on the capability needs of the user. The user's capability needs are identified in the user capability data. The processor 106 rates the required capability of the user identified in the user capability data (S302). The processor 106 correlates the rating of the existing capability with the rating of the required capability (S304).

Referring back to FIG. 2, once the analysis of the capability data is complete, the processor 106 establishes a capability profile of the project or objective based on the analysis (S204). The capability profile identifies any one of a deficiency, match, an overlap, or an excess in the existing capability of the user based on the correlation. The processor 106 sends the capability profile to the output device 108. The output device 108, such as a display, for example, displays the capability profile as a graph, matrix, chart, grid, or in any other suitable manner as desired (S206). The capability included in the capability profile can be deployed to the project for execution (S208).

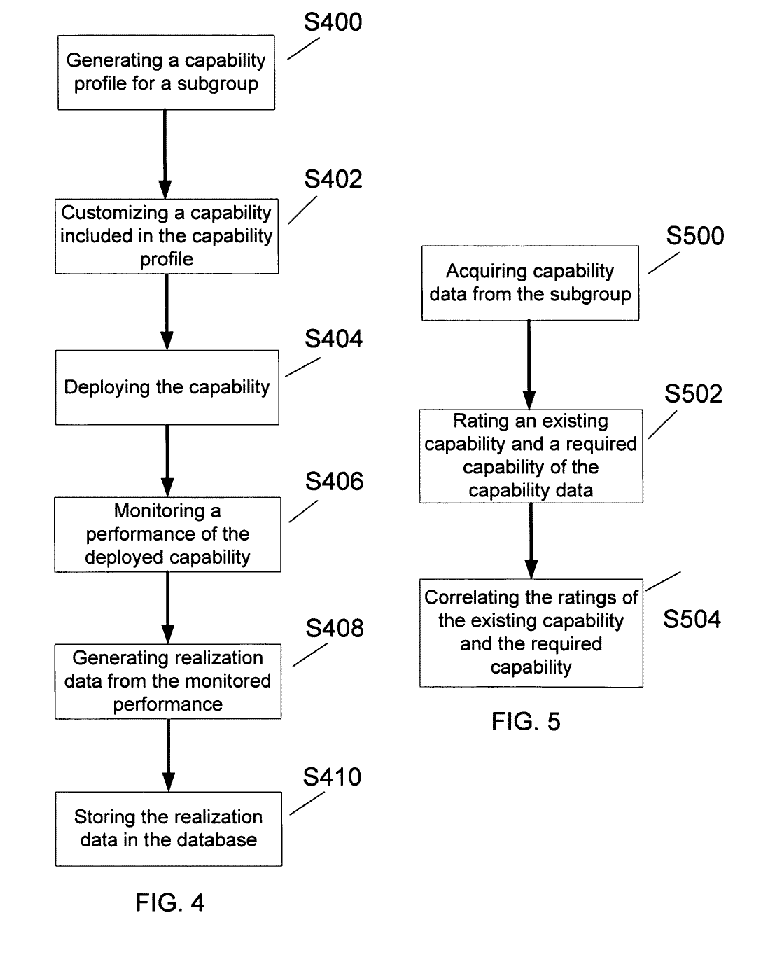

FIG. 4 is a flow diagram for a method of managing capabilities in a subgroup of an enterprise in accordance with an exemplary embodiment. As shown in FIG. 4, the processor 106 generates a capability profile for the subgroup (S400). The capability profile is associated with a project or objective to be completed by the subgroup. The processor 106 customizes a capability included in the capability profile (S402). The customized capability is deployed to the project for execution (S404). After the capability is deployed, a user can periodically enter information to the processor 106 via the user interface 104. As a result, the processor 106 can extract the capability template from the database 102 and compare the current status of the project with information, data, and/or established milestones to monitor the performance of the deployed capability (S406). For example, the processor 106 can use the information provided in the capability template to evaluate the deployment of the capability, how the capability is being used, whether the use of the capability complies with established guidelines, or any other suitable manner of evaluating the deployed capability as desired. The processor 106 generates realization data based on the monitored performance (S408). The processor 106 sends the realization data to the database 102 for storage (S410). The database 102 stores the realization data as an update to the capability template. The update can include the generation of a capability variant. The capability variant identifies a manner of tailoring the generic capability to achieve specified performance results with respect to a project associated with the capability template. In an alternative embodiment, the update can include modifying the generic capability.

FIG. 5 is a flow diagram for a method of generating a capability profile in accordance with an exemplary embodiment. In a first step, the processor 106 acquires capability data from the subgroup (S500). The capability data can be acquired from the subgroup via the user interface 104. The capability data is associated with the project or objective to be completed by the subgroup and identifies the existing capabilities of the subgroup. The capability data also identifies any capabilities that the subgroup does not currently possess but are required to complete the project or objective. Prior to inputting the capability data into the user interface 104, the combination of processes, tools, and people included in the capability data can be identified through interviews of subgroup members, questionnaires, surveys, or any other suitable manner of collecting data as desired.

The processor 106 separately rates both the existing capability and the required capability (S502). The capability rating of the existing capability is determined based on the capability needs of the subgroup. The processor 106 correlates the rating of the existing capability and the rating of the required capability (S504). The capability profile is generated based on the correlation result. The capability profile identifies one of a deficiency, a match, an overlap, or an excess in the existing capability as compared to the required capability.

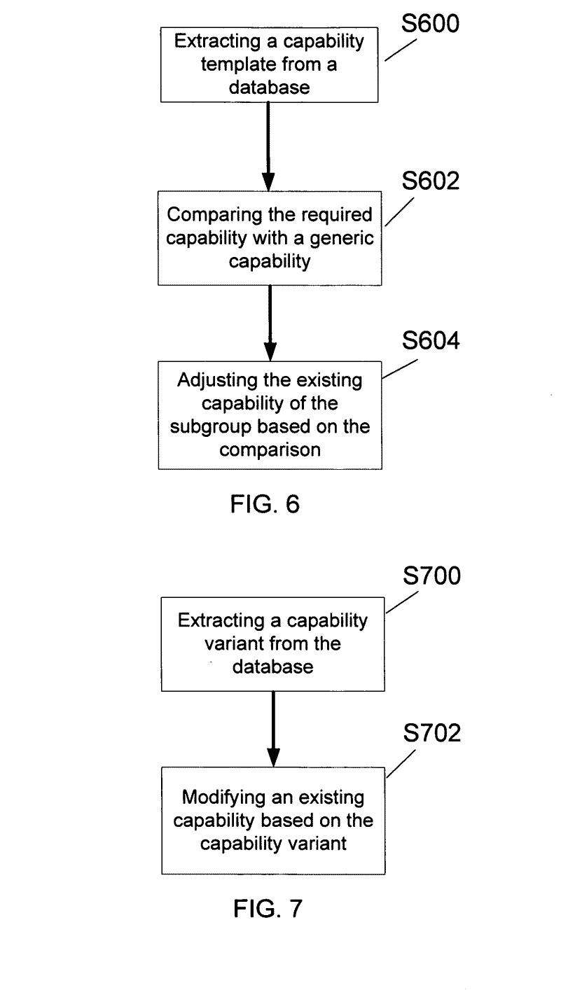

FIG. 6 is a flow diagram for a method of customizing capabilities in accordance with an exemplary embodiment. In a first step, the processor 106 extracts a capability template from the database 102 (S600). The capability template is associated with the project or objective to be completed by the subgroup. The processor 106 compares the required capability of the capability data of the subgroup with a generic capability of the capability of the capability template when the capability profile identifies one of a deficiency or an excess (S602). The processor 106 adjusts the existing capability of the subgroup based on the comparison (S604).

FIG. 7 is a flow diagram for a method of adjusting a capability in accordance with an exemplary embodiment. As shown in FIG. 7, the processor 106 extracts a capability variant from the database 102. The capability variant is associated with the generic capability. The processor 106 modifies the existing capability based on the capability variant.

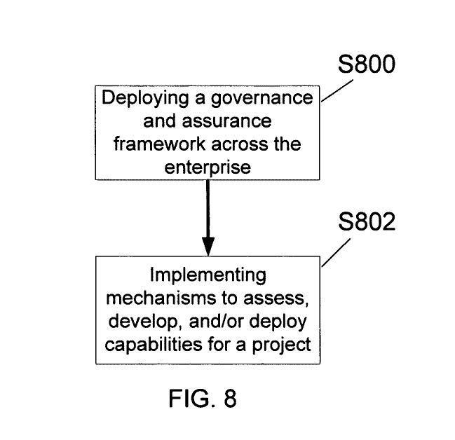

FIG. 8 shows a method of governing and assuring capability management in an enterprise in accordance with an exemplary embodiment.

To ensure that the identification, deployment, identification, development, assessment, and improvement in the capabilities of an organization, the system 100 and the associated methods as shown in FIGS. 1-7 can be implemented under a governing and assurance framework. As shown in FIG. 8, a governance and assurance framework is deployed across each subgroup of the enterprise (S800). The framework establishes the accountabilities and responsibilities for various aspects of supply chain management. For example, the governance structure of the framework refers to the implementation and maintenance of policies and procedures across each subgroup. The governance structure establishes terms of reference, procedures, and strategies so that the capabilities can be deployed, developed, assessed, improved, and identified under a best practices approach. The assurance structure of the framework includes the application of appraisals and/or reviews of the systems and methods of managing the capabilities to ascertain whether the governance structure is being practiced. If the governance structure is being practiced, the assurances can determine whether the manner of practice is compliant with established rules and/or procedures.

Once the framework is established mechanisms for at least one of assessing, developing, and deploying capabilities of each subgroup for a project are implemented (S802). These mechanisms establish a managing policy for the capabilities based on the governance and assurance framework such that best practices for the enterprise are sustainable, transferable, affordable, and repeatable within, across, and/or between subgroups of the enterprise.

The foregoing systems and methods provide several advantages. For example, through analyzing the capabilities of a user or subgroup the capabilities and skills of the people assets can be applied to a competency framework. Moreover, processes can be associated with particular role profiles. These role profiles can be further grouped into a job family. The analysis can be further used to identify gaps within a capability of the user or subgroup. The gap can be addressed through proper funding, training, recruiting, acquisitions, procurement, or any other suitable method to remove or reduce the deficiency.

The exemplary managing system and process as described above is related to supply chain management. However, it would be readily apparent to one of ordinary skill that the foregoing systems and methods can be implemented across various areas and disciplines of an enterprise. For example, the above exemplary embodiments can be directed to governing and/or managing engineering capabilities, modeling capabilities, maintenance capabilities, or any other capabilities of the organization as desired.

The systems and methods described herein can be implemented in software code that is stored on a computer readable medium. The computer readable medium can be used in configuring a computing device or processor, which is connected to a network of computing devices, to execute the aforementioned method for managing enterprise capabilities. One of ordinary skill in the art would appreciate that the computer readable medium can include an optical disk, floppy disk, flash memory, magnetic tape, or any other tangible source or medium as desired.

The systems and methods can also be implemented in software code that is transferred between at least two computing devices on a network through magnetic signals, optical signals, electrical signals, or any other medium for transferring data between devices on a network as desired.

While the invention has been described with reference to specific embodiments, this description is merely representative of the invention and is not to be construed as limiting the invention. Various modifications and applications may occur to those skilled in the art without departing from the true spirit and scope of the invention as defined by the appended claims.

What is claimed is:

1. A system that manages enterprise capabilities, the system comprising:
a database that stores a plurality of capability templates in an asset library;
a user interface configured to communicate with the database and receive capability data for a user project;
a processor configured to analyze the capability data based on at least one of the capability templates and generate a capability profile of the user project based on the analysis; and
a display that outputs the capability profile.

2. The system of claim 1, wherein the capability profile identifies one of a deficiency, a match, an overlap, or an excess in a user capability.

3. The system of claim 1, wherein the capability data includes information associated with at least one business process.

4. The system of claim 1, wherein the capability data includes information associated with at least one job role.

5. The system of claim 1, wherein the capability data includes information associated with at least one user tool.

6. The system of claim 1, wherein the database, the user interface, the processor, and the display are connected through a distributed computer network.

7. The system of claim 1, wherein the database, the user interface, the processor, and the display comprise a computing device.

8. The system of claim 1, wherein each capability template includes at least one generic capability.

9. The system of claim 8, wherein the database stores a capability variant for the at least one generic capability.

10. A method of managing enterprise capabilities, comprising:
acquiring capability data for a project;
analyzing the capability data based on a capability template stored in a database;
establishing a capability profile of the project based on the analysis; and
displaying the capability profile.

11. The method of claim 10, wherein the capability data includes at least one process, at least one job role, and at least one user tool.

12. The method of claim 10, wherein the capability data includes at least one existing capability of the user and at least one required capability of the project such that the analysis comprises:
rating the at least one existing capability of the user;
rating the at least one required capability of the user; and
correlating the rating of the at least one existing capability with the rating of the at least one required capability of the project.

13. The method of claim 12, wherein the capability profile identifies one of a deficiency, a match, an overlap, or an excess in the at least one existing capability of the user based on the correlation.

14. The method of claim 13, comprising:
deploying the at least one capability included in the capability profile to a project.

15. A method of managing capabilities of a subgroup in an enterprise, the method comprising:
generating a capability profile for the subgroup;
customizing, for the subgroup, at least one capability included in the capability profile; and
deploying, to a project, each capability included in the capability profile.

16. The method of claim 15, wherein generating the capability profile comprises:
acquiring capability data from the subgroup, wherein the capability data includes at least one existing capability of the subgroup and at least one required capability of the project;
rating each of the at least one existing capability and the at least one required capability; and
correlating the rating of the at least one existing capability with the rating of the at least one required capability.

17. The method of claim 16, wherein the capability profile identifies a deficiency, a match, an overlap, or an excess in the existing capability of the subgroup based on the correlation.

18. The method of claim 16, wherein customizing capabilities of the subgroup comprises:
extracting a capability template from a database;
comparing the at least one required capability of the subgroup with a generic capability of the capability template when the rating identifies one of a deficiency or an excess; and
adjusting the at least one existing capability of the subgroup based on the comparison.

19. The method of claim 18, wherein adjusting the at least one existing capability of the subgroup comprises:
extracting a capability variant from the database, wherein the capability variant is associated with the generic capability; and
modifying the at least one existing capability based on the capability variant.

20. The method of claim 18, wherein adjusting the at least one existing capability of the subgroup comprises one of expanding or reducing the existing capability.

21. The method of claim 15, further comprising:
extracting, from a database, at least one capability template that is associated with the capability profile.

22. The method of claim 15, further comprising:
monitoring a performance of each deployed capability;
generating realization data from the monitored performance; and
storing the realization data in the database as an update to the capability template.

23. The method of claim 22, wherein the update of the capability template includes one of generating a capability variant or modifying the generic capability.

24. A method of governing and assuring capability management in an enterprise, comprising:
deploying a governance and assurance framework across each subgroup of the enterprise; and
implementing mechanisms for at least one of assessing, developing, and deploying capabilities of each subgroup for a project,
wherein the mechanisms establish a managing policy for the capabilities based on the governance and assurance framework such that best practices for the enterprise are sustainable, transferable, affordable, and repeatable within, across, and/or between the subgroups of the enterprise.
